(19) United States
(12) Patent Application Publication
(10) Pub. No.: US 2011/0138936 A1
(43) Pub. Date: Jun. 16, 2011

(54) MEANS FOR TESTING FILTER INTEGRITY IN A LIQUID PURIFICATION SYSTEM

(75) Inventors: Gregory Collins, Monroe, NY (US); James Summerton, Park Ridge, NJ (US)

(73) Assignee: Nephros, Inc., River Edge, NJ (US)

(21) Appl. No.: 12/963,150

(22) Filed: Dec. 8, 2010

Related U.S. Application Data
(60) Provisional application No. 61/285,292, filed on Dec. 10, 2009.

(51) Int. Cl. G01N 1/10; B01D 35/00

(52) U.S. Cl. 73/863.23; 210/85; 210/90

(57) ABSTRACT

In one embodiment, a liquid purification system for purifying a liquid and delivering purified liquid to external downstream equipment includes a source of liquid to be purified and a filter device that is operatively coupled to and selectively in communication with the source of liquid. The filter device includes a filter element. The system also includes a controller and a means for performing a filter integrity test on the filter element, whereby the controller is configured to detect when purified liquid is being used by the downstream equipment and coordinate the initiation of the filter integrity test at time when conducting the filter integrity test does not adversely effect the operation of the downstream equipment.

### CROSS REFERENCE TO RELATED APPLICATION

This application claims the benefit of U.S. Patent Application Ser. No. 61/285,292, filed Dec. 10, 2009, which is hereby incorporated by reference in its entirety.

### TECHNICAL FIELD

The present invention relates to filtration equipment, and in particular, the present invention relates to a purification system that includes a single stage filter and a means to perform a filter integrity test on this filter.

### BACKGROUND

Various medical equipment, such as medical device reprocessing equipment, requires the use of purified water meeting certain levels of water quality. In particular, levels of bacteria, viruses, and endotoxins are of critical importance as these represent significant hazards to patients that are connected to or using devices that have been prepared with this equipment. As a result, purification of fluids used by or entering the equipment is of an utmost necessity. Filtration, and in particular ultrafiltration, is a common purification method to remove these microbiological contaminants from water before it is introduced into a certain piece of equipment. One way to assure sufficient quality of water feeding this equipment, is to use two filters in series, whereby if one filter were to lose its integrity (e.g. if there is a breach in the filter membrane), the other filter serves as a back-up.

As a back-up filter, contaminates are removed before the water is introduced to the equipment, thus rendering the water safe for use. Use of two filters in series, or a single filter with dual stages, however, is generally costly. In addition, these dual-filter systems typically result in lower flow rates as there is an added pressure drop caused by the second, redundant filter. It is also known in the art, that a single stage filter can be used, provided it has been tested to insure the membrane is intact. These tests are commonly called filter integrity tests and generally use pressurized air (or other suitable gas) as a means to verify membrane integrity. However, when water is purified before it enters a piece of equipment, such as by installing a water filter in the line feeding the equipment, there is no way to perform these integrity tests without possibly interrupting the flow of water to the piece of equipment. If this occurs when the equipment is commanding water, problems or errors will likely occur as the equipment may no longer function correctly. It is generally understood that this equipment performs automated functions and that water is used for discrete intervals of time (as opposed to using water on a continuous basis).

There is therefore a need for a system that allows for a filter integrity test to be performed such that it does not adversely effect the operation of the downstream equipment.

### SUMMARY

In accordance with the present invention and in view of overcoming the disadvantages associated with the conventional devices, a purification system includes a single stage filter and a means to perform a filter integrity test on this filter, whereby the purification system is able to detect when water is being used by the downstream equipment and thereby coordinate when a filter integrity test is to be performed that does not adversely effect the operation of the downstream equipment. In addition, the system permits a flushing of the upstream filter compartment to remove accumulated particulate from the source water which can increase the life of the filter. With the water purification system of the present invention, the filter flush steps can also be coordinated so as not to interfere with the operation of the downstream equipment. For example, the filter is flushed only when no water is being commanded by the downstream equipment.

In accordance with another embodiment, a method for performing a filter integrity test in a liquid purification system that is configured to purify a liquid from a liquid source using a filter device and deliver the purified liquid to external downstream equipment, includes the steps of: (1) monitoring when the external downstream equipment is receiving and using purified liquid from the filter device; and (2) initiating the filter integrity test only when the external downstream equipment is not commanding purified liquid.

### BRIEF DESCRIPTION OF THE DRAWINGS

FIG. 1 illustrates components of a liquid purification system in accordance with one embodiment of the present invention;

FIG. 2 is a cross-sectional view of a filter device used in the system of FIG. 1;

FIG. 3 illustrates the liquid purification system of FIG. 1 in a first standard operating mode where purified liquid is not delivered to external equipment;

FIG. 4 illustrates the liquid purification system of FIG. 1 in a second standard operating mode where purified liquid is delivered to the external equipment;

FIG. 5 illustrates the liquid purification system of FIG. 1 when a first step of a filter test operation is performed;

FIG. 6 illustrates the liquid purification system of FIG. 1 when a second step of a filter test operation is performed;

FIG. 7 illustrates the liquid purification system of FIG. 1 when a third step of a filter test operation is performed; and

FIG. 8 illustrates the liquid purification system of FIG. 1 when a filter flush operation is performed.

### DETAILED DESCRIPTION OF CERTAIN EMBODIMENTS OF THE INVENTION

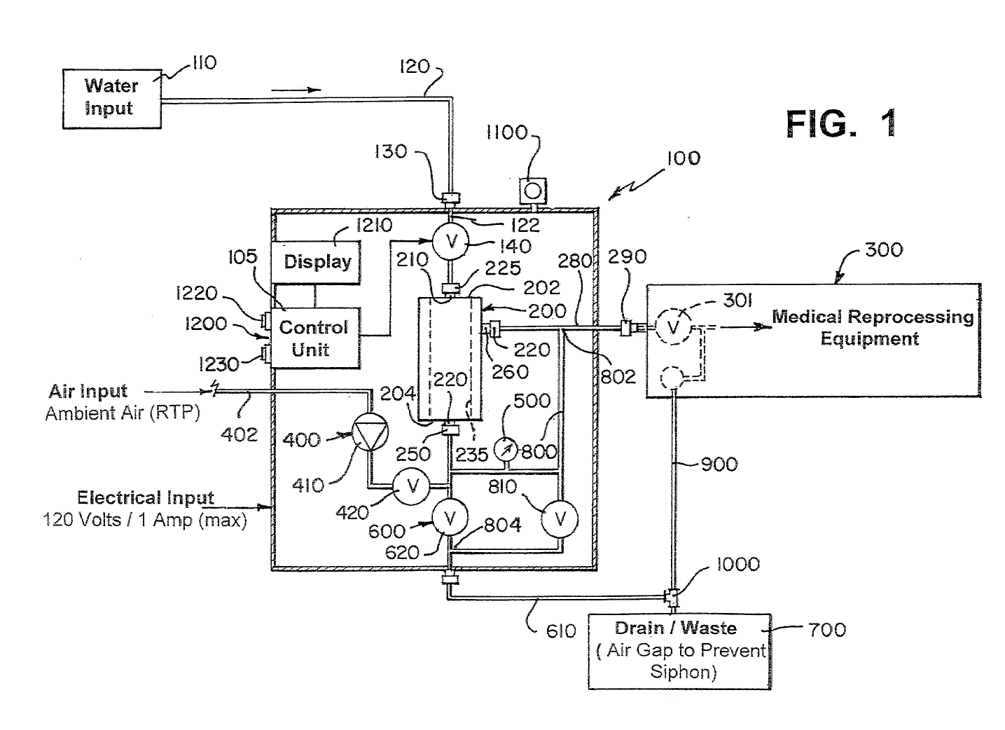

FIG. 1 illustrates a purification system 100 in accordance with the present invention. The purification system 100 includes a water source 110 that contains raw (unfiltered) water. The purification system 100 includes a filtration device 200 that is connected to the water source 110 via a first conduit 120. It will be appreciated that a first connector 130 can be used to connect the first conduit 120 to the filtration device 200. A conduit segment 122 extends from the first connector 130 to an inlet 210 of the filtration device 200 which can include a second connector 225. Along the conduit segment 122, a first valve 140 is provided and at least includes an open position and a closed position. The first valve 140 can be any number of different types of valves. As described below, the first valve 140 is in communication with a controller 105 that controls operation of the first valve 140.

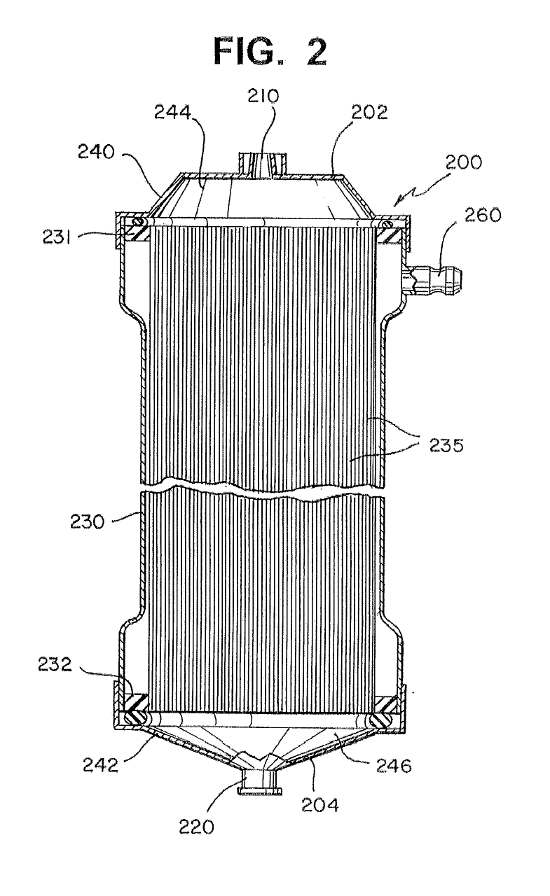

As shown in FIG. 2, the filtration device 200 includes a first end 202 and an opposing second end 204 with the inlet 210 being formed at the first end 202 and an outlet 220 being formed at the second end 204. The filtration device 200 includes a housing 230 that contains a plurality of semi-permeable membranes (first filter elements) 235 that serve as the filtering media of the device 200. The semi-permeable membranes 235 can be in the form of a plurality of fibers that are arranged in a bundle. The housing 230 also includes a pair of potting compounds 231, 232 that are disposed at opposite ends 202, 204 of the housing 230. The potting compound (e.g., polyurethane) provides an environmental barrier and encapsulates the semi-permeable membranes 235 in the housing 230. The potting compound forms a seal around the outside surfaces of the semi-permeable membranes. However, it will be appreciated that the potting compounds 231, 232 do not seal the ends of the semi-permeable membranes 235 but instead, the ends of the semi-permeable membranes 235 are open at ends 202, 204 of the housing 230.

The housing includes a first header cap 240 that is coupled to the first end 202 of the housing 230 and a second header cap 242 that is coupled to the second end 204 of the housing 230. Typically, the first and second header caps 240, 242 are removably (detachably) coupled to the housing 230. The first header cap 240 defines a first header space 244 that is formed between the first header cap 240 and the open ends of the semi-permeable membranes 235 and first potting compound 231. Similarly, the second header cap 242 defines a second header space 246 that is formed between the second header cap 242 and the opposite open ends of the semi-permeable membranes 235 and second potting compound 232.

The first header cap 240 includes a port that provides communication with the first header space 244 and thus, provides fluid communication with the semi-permeable membranes 235. In the illustrated embodiment, the port is in the form of inlet 210 since it permits fluid (from the source 110) to enter the first header space 244. Similarly, the second header cap 242 includes a port that communicated with the second header space 246 and thus, provides fluid communication with the semi-permeable membranes 235. This port is in the form of outlet 220 since it permits liquid to flow out of the housing.

While the filtering media has been described as a plurality of semi-permeable membranes (fibers), it will be appreciated that it can take other forms that suitable for the disclosed filter applications. In addition, the housing can have any number of different shapes.

It will also be appreciated that within the housing, there is a space between the inner surface of the housing and the semi-permeable membranes 235.

At the outlet 220, there is a third connector 250 (FIG. 1) that permits a conduit or line to be fluidly attached to the housing at this end.

The housing also includes a third port 260 that is located along a side thereof and communicates within an interior of the housing and in particular, is in communication with the space surrounding the semi-permeable membranes 235. In the illustrated arrangement, the third port 260 attaches to a fourth connector 270 (FIG. 1) that is connected to an output conduit or line 280 that is intended to carry purified (ultrafiltered) liquid (water) from the filter device 200 to an external device 300 that demands purified liquid. For example, the external device 300 can be in the form of medical reprocessing equipment that as discussed herein requires purified, ultrafiltered water. A fifth connector 290 can connect the conduit 280 to the external device 300.

The external device 300 includes a valve 301 that can be operated between an open position where fluid flows into the external device 300 and a closed position where fluid is prevented from flowing to the external device 300. The valve 301 is thus in fluid communication with the output conduit 280.

The purification system 100 includes a number of components that are configured to test the integrity of the filter device 200 in a manner that overcomes the disadvantages associated with conventional integrity test systems as described above.

In one embodiment, the system 100 includes an air input component 400 that is designed to introduce ambient air, at a selected time, into the filter device 200. More specifically, the air input component 400 serves to introduce ambient air into the interior of the filter device 200 and more particularly, into the hollow lumens of the semi-permeable membranes 235. The air is delivered from a source (e.g. atmosphere) and is delivered to the filter device 200 through a conduit 402 and by means of a pump 410 or the like. Along the conduit 402, a second valve 420 is provided and can be operated between an open position where air is delivered to the filter device 200 and a closed position. The second valve 420 is in communication with the controller 105.

In accordance with the present invention, a device 500 is provided for detecting and sensing pressure. More particularly, the device 500 is in the form of a differential pressure sensor (transducer) that measures the difference between two pressures introduced as inputs to a sensing unit that is part of the device 500. In the present embodiment, the pressure sensing device 500 can be used to measure the pressure differential across the filter media (i.e., semi-permeable membranes 235). For example, the pressure within the semi-permeable membranes 235 (inside the lumens) can be sensed and compared to an external pressure (outside the semi-permeable membranes 235). For example and as described below, the pressure sensing device 500 can be operatively connected to the device 200 to sense the pressure within the semi-permeable membranes 235 and the pressure within the output conduit or line 280 (e.g., of the output liquid downstream of the filter). In this manner, the pressure differential across the filter media (semi-permeable membranes 235) can be determined.

The purification system 100 includes a mechanism for flushing the filter device 200 and in particular, the filter device 200 can include a flush device 600 that includes a flush conduit or line 610. The flush conduit 610 is in fluid communication with a drain or waste 700 to permit the fluid that is used to flush the filter device 200 to be disposed of. Along the flush conduit 610, a third valve 620 is provided. The third valve 620 is operational between an open position where the fluid is delivered to the drain or waste 700 and a closed position. The third valve 620 is in communication with the controller 105.

The purification system 100 also includes a vent line or conduit 800. The vent line 800 includes a first end 802 and a second end 804 with the first end 802 being in fluid communication with the output conduit 280 and in particular, the first end 802 of the vent line 800 is located proximate the fourth connector 270. The second end 804 of the vent line 800 is in communication with the flush conduit 610 at a location downstream of the third valve 620. The vent line 800 is thus in fluid communication with the drain or waste 700. Along the vent line 800, a fourth valve 810 is provided. The fourth valve 810 is operational between an open position where the fluid is delivered to the drain or waste 700 and a closed position. The fourth valve 810 is in communication with the controller 105.

As shown in the figures, the drain or waste 700 can be fluidly connected to another conduit that delivers waste fluid to the waste 700. For example, a waste or drain line 900 that is associated with the external device 300 delivers waste fluid to the drain or waste 700. A tee connector 1000 can be provided for linking the flush conduit 610 and the drain line 900 with the drain or waste 700.

In addition with one aspect of the present invention, a device 1100 for displaying an integrity status signal can be provided. The device 1100 can display different information and indicia for indicating the operating status of the purification system 100. For example, the device 1100 can display an indicator that the filter (filter device 200) passed the integrity test and an indicator that the filter failed the integrity test. For example, the word “PASS” or “FAIL” can be displayed or a green light can be displayed when the filter passes and a red light can be displayed when the filter fails.

In addition, a user interface 1200 can be provided and includes a display 1210, a first button 1220 and a second button 1230. The user interface 1200 may allow the user to set various parameters associated with its operation for a particular type of equipment. The display 1210 can be a single line display showing the filtration process step as described below.

It also should be understood that the water purification system 100 can include buttons, such as buttons 1220, 1230 to reset the summed number of “Fill” or “Use” operations at any point in time such that is stays coordinated with the downstream equipment operations. An additional Button may also be included to allow the user to replace the filter without shutting off the source water and perform an automated priming routine (not shown). For example, the button 1220 can be a filter “install” button and upon actuation, results in the closing of the first valve 140 and allows one to install a new filter 200 and then prime the filter 200. The button 1230 can be a reset “fill counter” button to provide a means for the purification system 100 to be in sync. with the start of the reprocessing equipment cycle.

In accordance with the present invention, the purification system 100 is configured using a single stage filter (filter device 200) and a means to perform a filter integrity test on this filter, whereby the purification system 100 is able to detect when water is being used by the downstream equipment and thereby coordinate when a filter integrity test is to be performed that does not adversely affect the operation of the downstream equipment. In addition, a flushing of the upstream filter compartment to remove accumulated particulate from the source water is used to increase the life of the filter. With the water purification system 100 of the present invention, the filter flush steps can also be coordinated so as not to interfere with the operation of the downstream equipment 300. For example, the filter (filter device 200) can be flushed only when no water is being commanded by the downstream equipment 300.

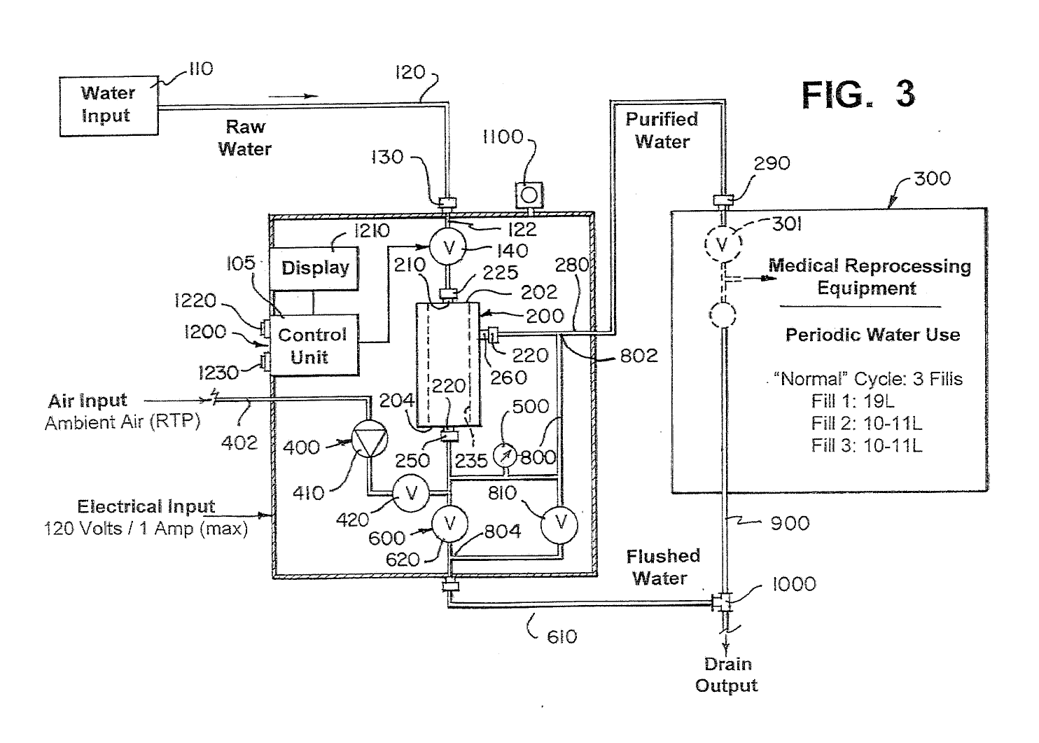

In accordance with the present invention, there are a number of operating modes of the purification system 100 as described below and as illustrated in FIGS. 3-8. FIG. 3 shows a standard operating mode when the external downstream equipment 300 does not command water and the valve 301 is closed. In this operating mode, purified water that has been filtered by the device 200 is not delivered to the external equipment 300. The pressure sensing device 500 detects that the differential pressure across the filter membrane (semi-permeable membranes 235) is zero since the upstream pressure (pressure within the semi-permeable membranes 235) is at least substantially equal to the downstream pressure (the pressure within the output conduit or line 280) when no flow across the membrane occurs.

The valves 420, 620, 810 are closed in this operating mode.

In this operating mode the purification system 100 is in an IDLE state and the device 1100 can display positive information regarding the operating state.

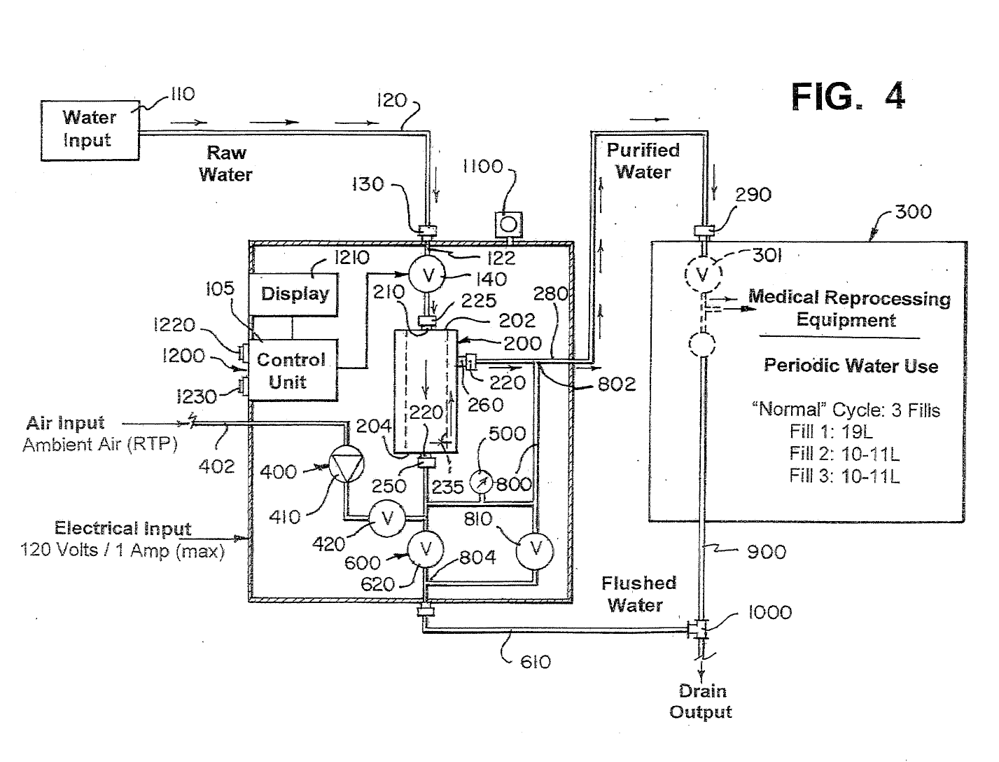

FIG. 4 shows another standard operating mode when the external downstream equipment 300 commands purified fluid (water) by opening its fluid inlet valve 301. Purified fluid (water) is delivered to the external downstream equipment 300, for example during a FILL or RINSE operation. In this operating mode, the differential pressure across the filter membrane (semi-permeable membranes 235) becomes positive (upstream pressure is greater than downstream pressure) as detected by the device 500. The signal is monitored by the control unit (controller 105) and upon seeing a positive level (e.g., a level that exceeds a pre-determined threshold), the control unit 105 stores this as a “fill” or “use” operation in its memory. Successive “fill” or “use” operations are also detected, whereby a total sum of “fill” or “use” operations detected can be stored in the internal memory of the control unit.

As shown, the fluid (water) is filtered by flowing from the source 110 into the filter device 200 and is then filtered across the semi-permeable membranes 235 to generate purified liquid that is flows out through the third port 260 into the output conduit 280 to the external device 300. The valves 420, 620, 810 are closed in this operating mode.

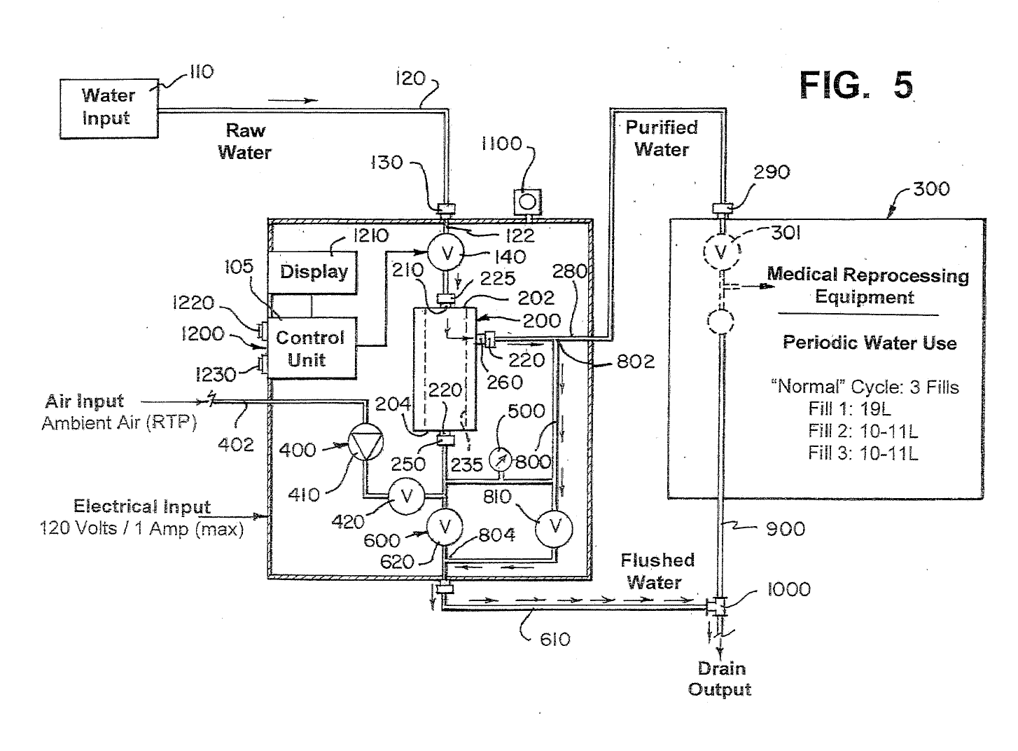

FIG. 5 shows an integrity filter test process and in particular, FIG. 5 shows a first step of the integrity filter test process. In particular, the first step is process where the filter device 200 is vented. After a predetermined number of “fill” or “use” operations have been detected, a filter test routine or process is initiated whereby the inlet valve (first valve) 140 is closed and the vent valve 810 is open to vent the filter pressure. As the filter pressure vents, fluid (water) temporarily flows across the filter membrane 235 and a positive differential pressure is detected by the differential pressure transducer 500. When the pressure has equilibrated to atmospheric pressure on both sides of the membrane 235 (inside the lumen and outside), the differential pressure returns to zero indicating the end of this step.

In this embodiment, the water that does filter across the membrane 235 flows out of the third port 260 and flows along conduits 800 and 610 to the drain 700 since the vent valve 810 is open.

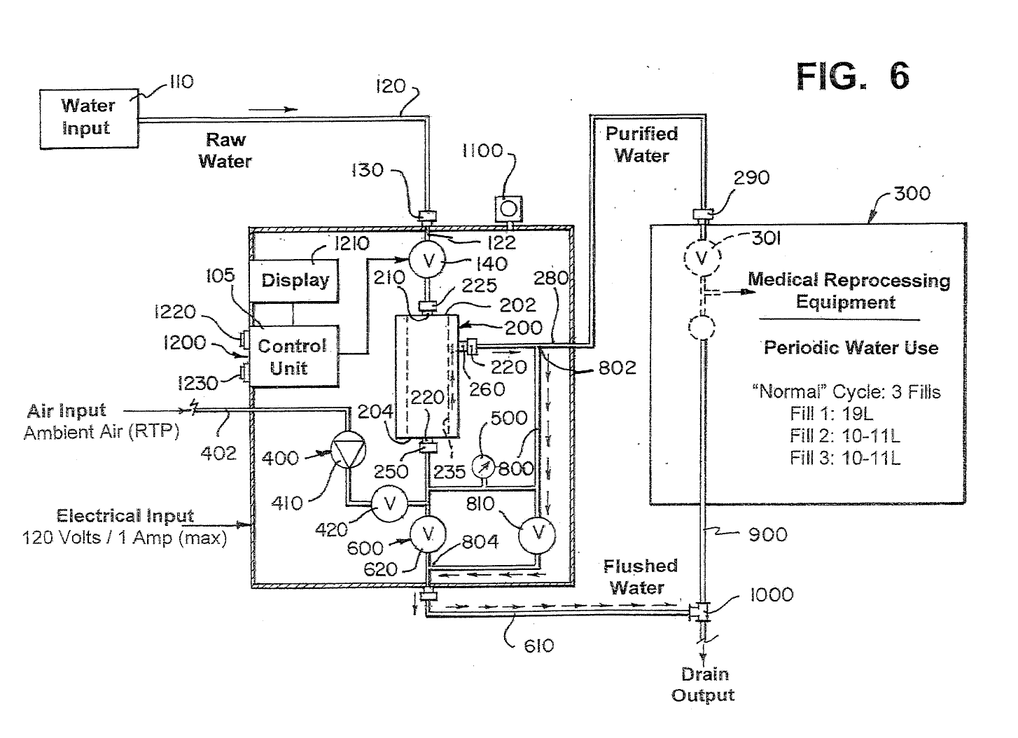

FIG. 6 shows an integrity filter test process and in particular, FIG. 6 shows a second step of the integrity filter test process. The second step is a step where the filter device 200 is pressurized with air. In this operating mode, the air valve 420 is opened and the pump 410 is turned on to fill the upstream compartment (membranes 235) of the filter 200 with air. The air displaces the internal water whereby it is pushed across the filter membrane 235 and flows along the vent line 800 to the drain output 700.

Since air cannot cross an intact membrane, the air pressure on the inlet side of the membrane will increase. Upon reaching a specified level as measured by the differential pressure transducer 500, the air pump 410 is stopped and the air valve 420 is closed.

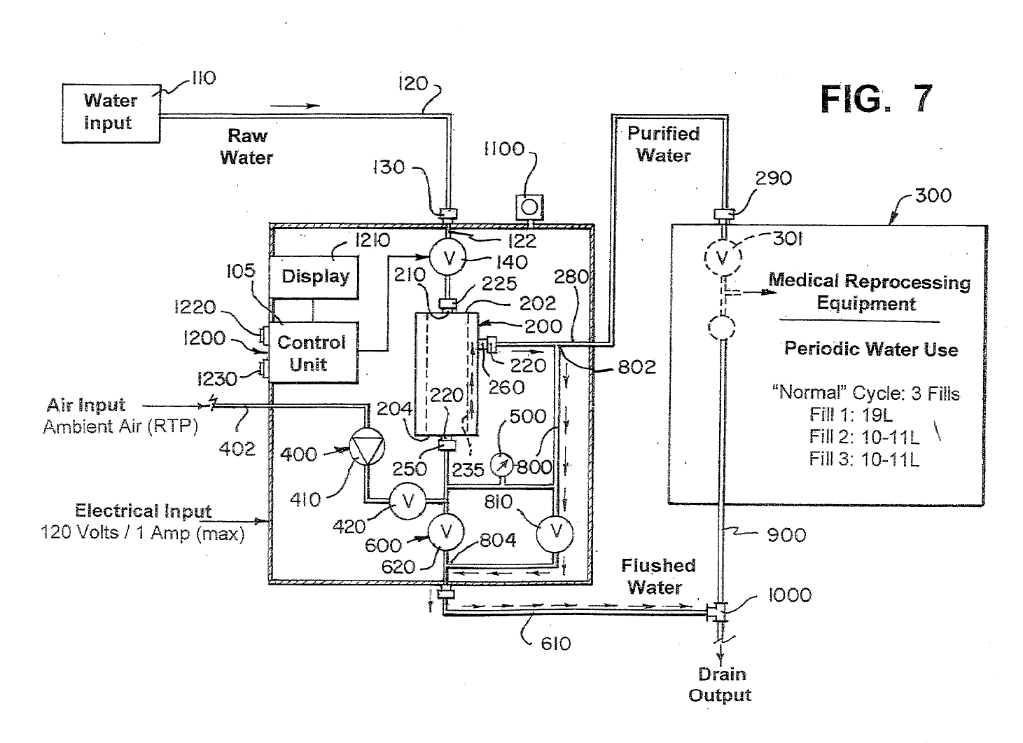

FIG. 7 shows an integrity filter test process and in particular, FIG. 7 shows a third step of the integrity filter test process. The third step is a pressure decay measurement step. In this mode, the air valve 420 is closed and a specified stabilization period is performed to allow pressures to stabilize. Upon completion of the stabilization period, the starting pressure measured at the differential pressure transducer 500 is recorded and the ending pressure is recorded after a specified test period has elapsed. The net difference between these readings (starting pressure minus ending pressure) is compared to a pre-established value to determine if the filter (filter device 200) passes or fails the integrity test.

Upon passing the integrity test, the “fill” or “use” counter may be reset to zero and the system 100 may be put into its standard operating mode as described above. Upon failing the integrity test, the inlet valve 140 may be kept closed to prevent any subsequent passage of water to the downstream equipment 300. An optional red status light (display 1100) can be illuminated to alert the user that the filter 200 failed and must be replaced. Upon replacing the filter 200, the user can repeat the cycle performed by the downstream equipment. This assures that only good purified liquid (water) from an intact filter is delivered to the downstream equipment 300.

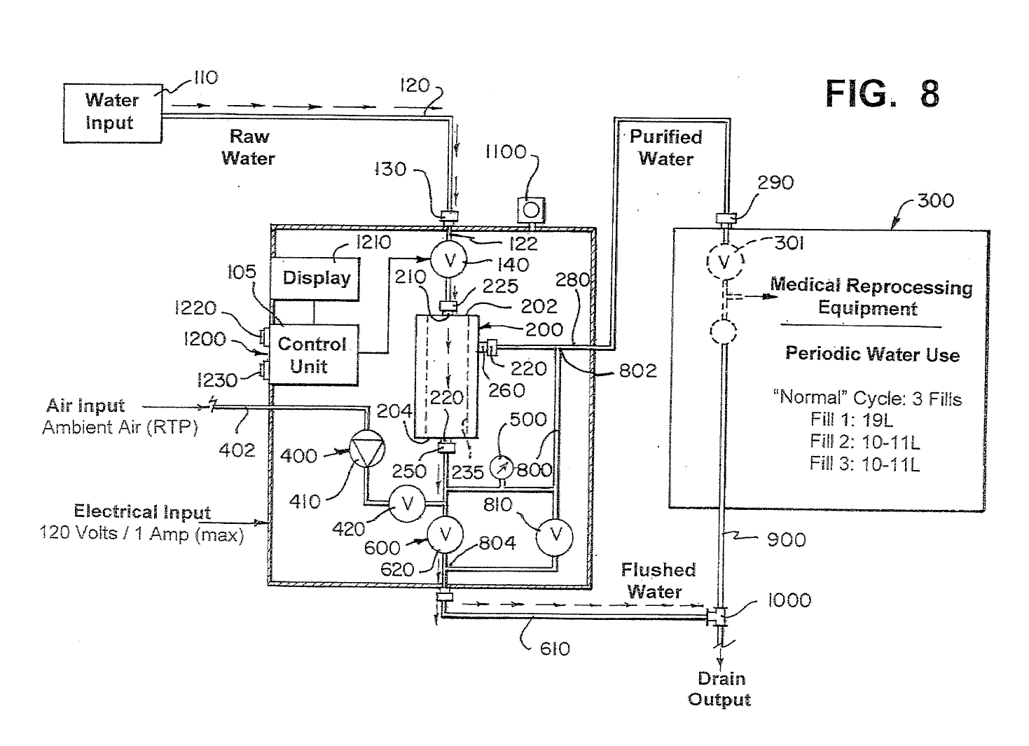

FIG. 8 shows a filter flush operation which involves the periodic flushing of the upstream filter compartment. One advantage of the purification system 100 is that a flush routine can be performed in a manner that does not interfere with the downstream equipment 300. In other words, it can be performed when the downstream equipment 300 is IDLE (i.e., not calling for water).

When the downstream equipment 300 is in an IDLE period with respect to the fluid (water) feed, the pressure differential will be zero. Provided this is true, the flush valve 620 may be open for a specified period of time to flush accumulated particulate from the upstream side of the filter 200. This has the effect of increasing the useful life of the filter before it becomes too fouled to produce a sufficient quantity of water for the downstream equipment. One will appreciate that the flush operation can be programmed to occur at a set frequency or it can be tied to a set number of “fill” or “use” operations that have been detected.

At the end of the flush period, the flush valve 620 is closed and the system 100 is placed back in the standard operating mode as described herein.

Other features and advantages of the system 100 include but are not limited to the following: (1) by tracking the differential pressure (Pdiff) over time when water is being delivered to the downstream equipment, one can set a specified level at which may indicate the filter is sufficiently “fouled” and should be replaced; (2) a separate signal (such as an electrical signal) can be generated by the system and sent to the downstream equipment 300 which can be used to determine the status of water purification unit 100, e.g. the signal could be different when the filter has FAILED an integrity test—this signal can be used to alert the user of the downstream equipment that there is a problem with the water purification unit; (3) different mechanisms that are known in the art can be used to detect when the water is being commanded by the downstream equipment 300. For example, a flow detector or flow switch can be used to detect the flowing condition; and (4) it will be appreciated that different methods that are known in the art can be used to test filter integrity—this can include an air bubble detection unit on the downstream side of the filter as a Bubble-point type measurement, or an Air Flow test whereby the flow rate of air is measured which is needed to maintain a constant pressure in the upstream compartment.

It will also be appreciated that the flow configuration described and illustrated herein is one of many configurations that can be used. The illustrated configuration is presented as it minimizes the components in the feed stream to the downstream equipment and thereby keeps the flow of water to the downstream equipment at a maximum level (i.e. no additional flow resistances).

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A liquid purification system for purifying a liquid and delivering purified liquid to external downstream equipment, comprising:
a source of liquid to be purified;
a filter device that is operatively coupled to and selectively in communication with the source of liquid, the filter device including a filter element;
a controller; and
a means for performing a filter integrity test on the filter element, whereby the controller is in communication with the first filter device and the means for performing the filter integrity test on the filter element and is configured to detect when purified liquid is being used by the downstream equipment and coordinate an initiation of the filter integrity test at time when conducting the filter integrity test does not adversely affect the operation of the downstream equipment.

2. The system of claim 1, wherein the external downstream equipment comprises medical reprocessing equipment that requires purified liquid.

3. The system of claim 1, wherein the filter device comprises a housing that contains the filter element which is in the form of a plurality of semi-permeable membranes with the source of liquid being in selective communication with inner lumens of the semi-permeable membranes and the external downstream equipment is in selective communication with an interior of the housing external the semi-permeable membranes.

4. The system of claim 1, further including a plurality of valves including a first controllable valve that is disposed in a first conduit that extends between the source of liquid and an inlet of the filter device and a second controllable valve that is disposed within an output conduit that extends between the filter device and the external downstream equipment and a plurality of secondary controllable valves that are connected between the means for performing the filter integrity test on the filter element and the filter device to permit the means to be in selective fluid communication with the filter device.

5. The system of claim 1, wherein the means for performing the filter integrity test on the filter element and the filter device includes a pressure sensing device that senses pressure within the filter element and pressure within the output conduit and allows the controller to determine a pressure differential across the filter element, whereby the filter integrity test is conducted based on this pressure differential.

6. The system of claim 5, wherein the means for performing the filter integrity test on the filter element includes:
a first device for introducing air into the filter element under select conditions and via an air conduit that is in fluid communication with the filter element, the first device being in communication with the controller;
a second device for flushing the filter element, the second device including a flush conduit that is in fluid communication with an outlet of the filter device and a drain, the second device being in communication with the controller; and
a vent conduit that has a first end in fluid communication with the output conduit and a second end in fluid communication with the flush conduit to permit venting of fluid within the filter device.

7. The system of claim 6, wherein the first device includes a source of air and the air conduit is in fluid communication with the flush conduit at a location that is upstream of a flush valve that is located within the flush conduit, the air conduit including an air valve for controlling flow of air into the filter device, the first end of the vent conduit being located upstream of an output valve that is located along the output conduit, the second end of the vent conduit being located downstream of the flush valve, the vent conduit including a vent valve, the pressure sensing device sensing a pressure within the flush conduit and a pressure within the vent conduit for determining a pressure differential across the filter element.

8. The system of claim 7, wherein the means for performing the filter integrity test on the filter element includes a plurality of different operating modes including a first normal operating mode when the external downstream equipment is not commanding water and the output valve in the output conduit is closed, the pressure sensing device detecting that a pressure differential across the filter element is zero.

9. The system of claim 8, wherein the plurality of different operating modes includes a second normal operating mode when the external downstream equipment commands water and the output valve is open, the pressure sensing device detecting that a pressure differential across the filter element is a positive value.

10. The system of claim 9, wherein the controller has memory and a counter and each time the pressure sensing device detects a positive pressure differential, the controller stores in the memory this event as representing that the downstream equipment is in use.

11. The system of claim 7, wherein the means for performing the filter integrity test on the filter element includes a first step in which the filter device is vented with an input valve that is located in an input conduit that delivers the liquid to an inlet of the filter device being closed, wherein the vent valve is open to vent the filter device and the liquid at least temporarily flows across the filter element and a positive pressure differential is detected by the pressure sensing device until the pressure equilibriates to atmospheric pressure on both sides of the filter element, the first step concluding when the pressure differential returns to zero.

12. The system of claim 11, wherein the means for performing the filter integrity test on the filter element includes a second step in which the air valve is opened and pressurized air is delivered through the air conduit and inside the filter element, thereby causing liquid within the filter element to be conducted across the filter element and flow out the vent conduit, the second step concluding when the measured pressure differential achieves a predetermined value.

13. The step of claim 12, wherein the means for performing the filter integrity test on the filter element includes a third step which comprises a pressure decay measurement step, the air valve being closed and a specified stabilization period is performed to allow pressures to stabilize and the means is configured such that upon completion of the stabilization period, the pressure sensing device measures a starting pressure and an ending pressure after a specified test period has elapsed, the controller determining a difference between the starting and ending pressures and comparing the difference to a prescribed value to determine if the filter device passes or fails the integrity test.

14. The system of claim 1, wherein the means for performing the filter integrity test on the filter element is configured to detect when fluid is being used by the downstream equipment and coordinate that the filter integrity test is performed at a time that does not adversely affect the operation of the downstream equipment.

15. The system of claim 1, wherein the means for performing the filter integrity test on the filter element includes a system for flushing the filter device to remove accumulated particulate from the source of liquid to increase the life of the filter element, wherein the controller instructs flushing of the filter device only when no liquid is being commanded by the downstream equipment.

16. A method for performing a filter integrity test in a liquid purification system that is configured to purify a liquid from a liquid source using a filter device and deliver the purified liquid to external downstream equipment, comprising the steps of:
monitoring when the external downstream equipment is receiving and using purified liquid from the filter device; and
initiating the filter integrity test only when the external downstream equipment is not commanding purified liquid.

17. The method of claim 16, further including the step of determining a pressure differential across a filter element of the filter device and conducting the filter integrity test based on this pressure differential.

18. The method of claim 16, wherein the step of initiating the filter integrity test comprises the steps of:
closing an output valve to prevent the purified liquid from being delivered to the external downstream equipment;
closing an input valve to prevent liquid from being delivered from the liquid source to the filter device;
venting pressure within the filter device and permitting any purified liquid contained within the filter device to drain;
pressuring the filter device with air resulting in liquid within the filter device being conducted across the filter element and draining from the filter device; and
performing a pressure decay measurement to determine if the filter device passes or fails the pressure integrity test.

19. The method of claim 18, wherein the step of performing the pressure decay measurement includes the steps of:
stopping the delivery of air to the filter device and performing a specified stabilization period to allow pressures within the system to stabilize;
upon completion of the stabilization period, measuring a starting pressure and an ending pressure after a specified test period has elapsed;
determining a net difference between the starting pressure and the ending pressure; and
comparing the net difference to a prescribed threshold value to determine if the filter device passes or fails the pressure integrity test.

20. The method of claim 16, further including the step of using a counter to determine a number of times the external downstream equipment has operated under normal operating conditions and had purified liquid delivered thereto and initiating the filter integrity test when the counter reaches a prescribed value and upon completion of the filter integrity test, resetting the counter to zero.
